(19) United States
(12) Patent Application Publication
(10) Pub. No.: US 2011/0286228 A1
(43) Pub. Date: Nov. 24, 2011

(54) VEHICLE HEADLIGHT AND ASSEMBLING METHOD THEREOF

(76) Inventor: Yasuyuki Zanma, Utsunomiya-shi (JP)

(21) Appl. No.: 13/113,558

(22) Filed: May 23, 2011

(30) Foreign Application Priority Data
May 21, 2010 (JP) 2010-116933

(51) Int. Cl. F21V 7/00; B23P 17/04

(52) U.S. Cl. 362/516; 29/428

(57) ABSTRACT

A vehicle headlight can include a housing including a front surface provided with an opening, a reflector which reflects light, and a supporting member including a plurality of shaft bearing portions which support the reflector. The supporting member can be made in such a way that at least the shaft bearing portions have flexibility, and engage with the housing in a vicinity of the opening of the front surface of the housing so as to be fixed to the housing. The housing can be configured to support the reflector via the supporting member disposed in the housing in such a way that the reflector is tiltable in the housing.

This application claims the priority benefit under 35 U.S.C. §119 of Japanese Patent Application No. 2010-116933 filed on May 21, 2010, which is hereby incorporated in its entirety by reference.

### BACKGROUND

1. Field

The presently disclosed subject matter relates to a vehicle headlight including an aiming adjustment mechanism and to an assembling method of the headlight.

2. Description of the Related Art

Conventionally, there is known a vehicle headlight including a so-called aiming adjustment mechanism by which the direction of an optical axis is adjusted, for example, according to Japanese Patent Application Laid-open Publication No. 2000-195326.

As such a conventional vehicle headlight, for example, a vehicle headlight 100 shown in FIG. 6A is assembled by installing a reflector 140, an extension 150, and a lens 160 in a housing 110 in the order named, the housing 110 which houses a bulb 120 and an aiming screw 130. The reflector 140 is pressed into the housing 110 in such a way that aiming shafts 140a, 140a which are bilaterally disposed on the lateral surface of the reflector 140 are respectively fitted into and supported by shaft bearing holes 110a, 110a which are bilaterally disposed on the bottom (back) portion of the housing 110. The reflector 140 is connected with the aiming screw 130 at the back side of the bottom (back) surface of the reflector 140. By torsionally rotating the aiming screw 130, the reflector 140 tilts in a rotatory direction of the aiming shafts 140a, 140a. Accordingly, the aiming adjustment can be performed.

However, there are a number of problems associated with the headlight 100.

First, it is difficult to properly install the reflector 140 in the housing 110 by inserting the reflector 140 into the housing 110 to the bottom portion of the housing 110 while holding the outer side of the lateral surface of the reflector 140. There is a case where the reflector 140 is obliquely inserted into the housing 110 as shown in FIG. 6B. It is because, in order to secure a reflective area, the reflector 140 is formed along the inner wall of the housing 110, particularly when the headlight 100 is small, and consequently, there is almost no gap between the inner wall of the housing 110 and the lateral surface of the reflector 140. Thus, it is difficult to properly install the reflector 140 in the housing 110 by inserting the reflector 140 into the housing 110 to the bottom portion of the housing 110 while holding the outer side of the lateral surface of the reflector 140. Furthermore, since the inner side of the lateral surface of the reflector 140 is the reflective area, it is inappropriate to hold the inner side thereof instead of the outer side thereof.

Secondly, it is difficult to judge whether an error occurs in fitting the aiming shafts 140a, 140a into the shaft bearing holes 110a, 110a as shown in FIG. 6C. It is because, since there is almost no gap between the reflector 140 and housing 110 as described above, it is difficult to visually recognize the bottom portion of the housing 110 from such a very narrow gap.

Thirdly, the reflector 140 may be broken by the opposing force against the pressing from the housing 110 as the reflector 140 is directly pressed into the housing 110. It is because material having a certain degree of hardness is used for the reflector 140 in order to secure a certain level of accuracy of light distribution or a higher level thereof, and the housing 110 is formed to be robust for being used as a case. Furthermore, when the broken part is located at the bottom portion of the reflector 140, such a broken part may not be visually recognized, and may be overlooked.

### SUMMARY

In the view of the circumstances, one aspect of the disclosed subject matter is to provide a properly-assembled vehicle headlight in which the direction of an optical axis is can be adjusted, namely an aiming adjustment can be performed, and an assembling method of the headlight.

To solve or address at least one of the problems described above, according to a first aspect of the presently disclosed subject matter, there is provided a vehicle headlight including: a housing including a front surface provided with an opening; a reflector which reflects light; and a supporting member including a plurality of shaft bearing portions which support the reflector, wherein the supporting member is made in such a way that at least the shaft bearing portions have flexibility, and engages with the housing in a vicinity of the opening of the front surface of the housing so as to be fixed to the housing, and the housing supports the reflector via the supporting member disposed in the housing in such a way that the reflector is tiltable in the housing.

According to a second aspect of the presently disclosed subject matter, there is provided an assembling method of a vehicle headlight including: supporting a reflector by a plurality of shaft bearing portions of a supporting member, wherein the reflector reflects light, the supporting member is made in such a way that at least the shaft bearing portions have flexibility, and the supporting member is capable of engaging with a housing in a vicinity of an opening of a front surface of the housing; inserting the supporting member with the reflector into the housing while holding the supporting member; and engaging the supporting member with the housing so as to fix the supporting member to the housing, wherein the reflector is tiltable in the housing.

### BRIEF DESCRIPTION OF THE DRAWINGS

The above and other characteristics, advantageous and features of the presently disclosed subject matter will become more fully understood from the detailed description given hereinbelow and the appended drawings which are given by way of illustration only, and thus are not intended as a definition of the limits of the presently disclosed subject matter, wherein:

FIG. 1 is an exploded perspective view of a vehicle headlight according to an exemplary embodiment of the presently disclosed subject matter;

FIG. 2 is a plan view of the headlight;

FIG. 3 is a perspective view of the headlight viewed obliquely from the back thereof;

FIG. 4 is a sectional view of the headlight taken along the line A-A of FIG. 2;

FIGS. 5A to 5C are illustrations to explain steps in assembling an aiming screw of the headlight; and

FIG. 6A is a plan view of a conventional vehicle headlight, FIG. 6B shows an error in assembling the headlight of FIG. 6A, and FIG. 6C shows another error in assembling the headlight of FIG. 6A.

### DESCRIPTION OF EXEMPLARY EMBODIMENTS

Hereinafter, an embodiment of the presently disclosed subject matter is described in detail referring to the drawings. The drawings are given by way of illustration only, and thus are not intended to limit the scope of the presently disclosed subject matter.

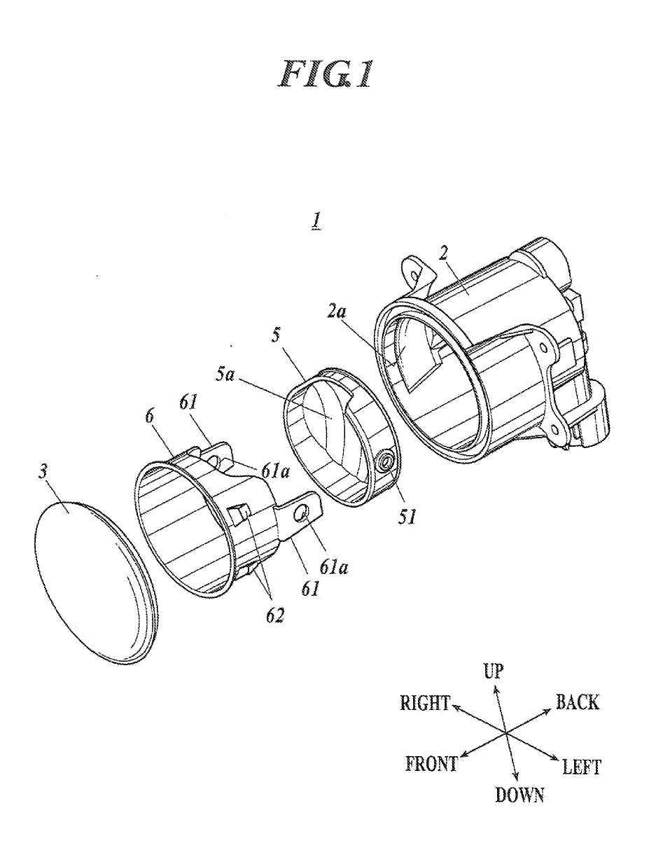

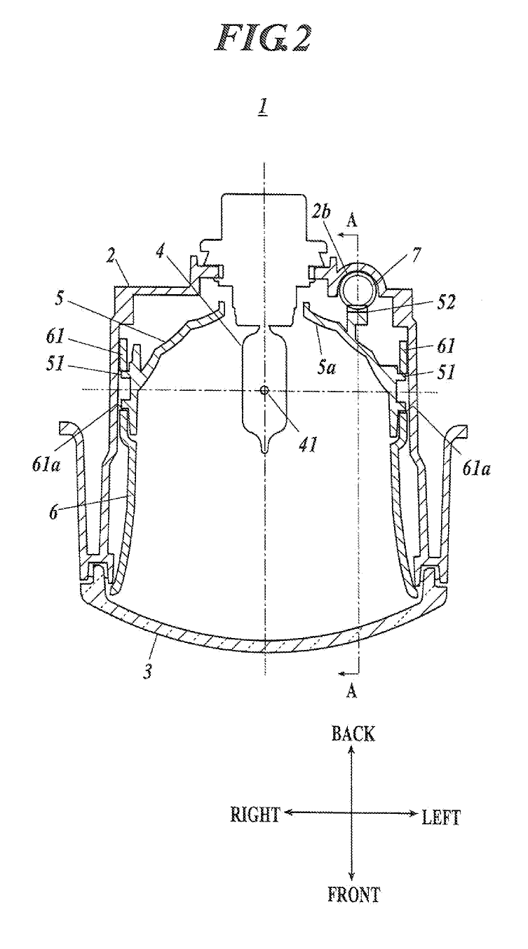

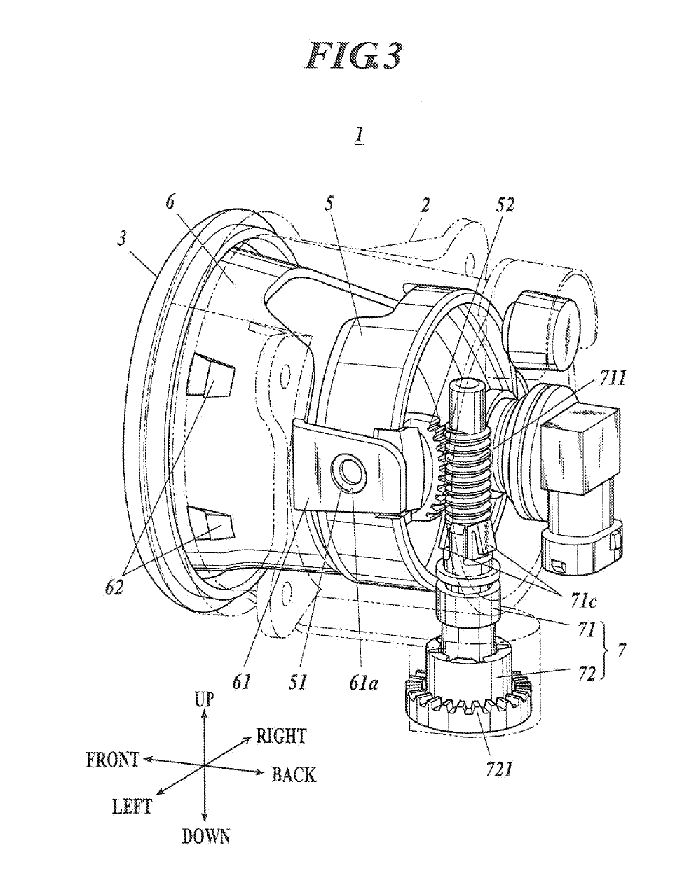

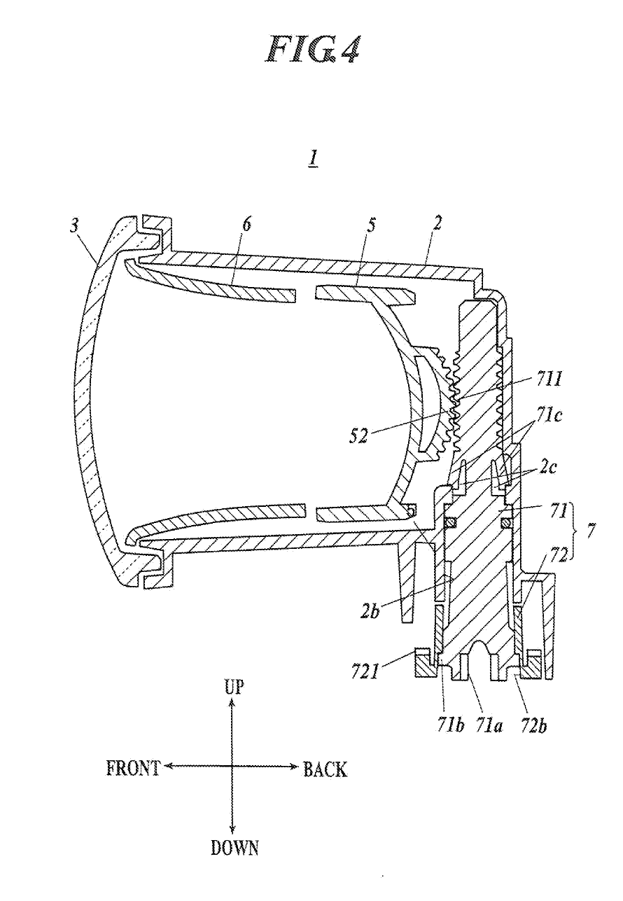

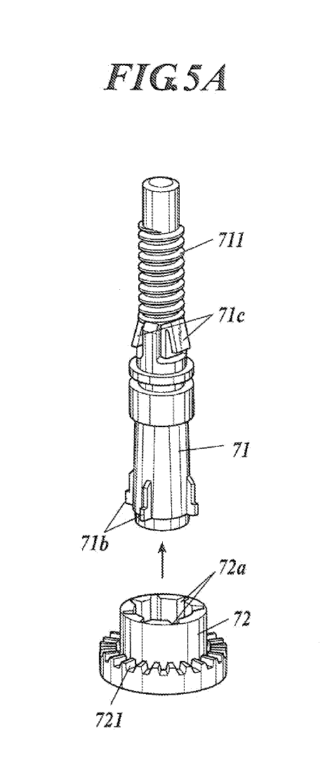

FIG. 1 is an exploded perspective view of a vehicle headlight 1 made in accordance with principles of the disclosed subject matter, FIG. 2 is a plan view of the headlight 1, FIG. 3 is a perspective view of the headlight 1 viewed obliquely from the back thereof, and FIG. 4 is a sectional view of the headlight 1 taken along the line A-A of FIG. 2.

In the following, words of “front”, “back/bottom”, “right”, “left”, “up/upper”, and “down/lower” are used for indicating a direction of and a position in the headlight 1, the words which correspond to words written in the drawings. The words are used only for making it easy to understand the presently disclosed subject matter, and hence, do not limit the direction of and the position in the headlight 1 at the time of installation of the headlight 1 in a vehicle.

As shown in FIGS. 1 and 2, the headlight 1 can include a near-cylindrical housing 2 having a front surface provided with an opening, and a lens 3 fixed to the housing 2 in such a way as to cover the opening of the front surface of the housing 2. A bulb 4, a reflector 5, an extension (supporting member) 6, and an aiming screw 7 are housed in a light room formed by the housing 2 and the lens 3.

The bulb 4 includes a filament 41 as a light source, and is fixed to the center of the back (bottom) surface of the housing 2 in such a way as to stand up toward the opening of the front surface of the housing 2.

The reflector 5 reflects light emitted from the filament 41 of the bulb 4. The reflector 5 can be formed to be a circular concave plate, and provided with an opening at the center of the bottom surface thereof. The bottom surface of the reflector 5 is a reflection surface 5a having a shape of a near paraboloid of revolution. Two aiming shafts 51, 51 are respectively formed at the right end and the left end of the outer side of the lateral surface of the reflector 5 in such a way as to project into the right/left direction. The reflector 5 is supported by the housing 2 via the extension 6 in such a way as to be tiltable in the housing 2 in a rotatory direction of the aiming shafts 51, 51, in a state where the focus of the reflection surface 5a is located in the vicinity of the filament 41, the filament 41 is located on the central axis of the aiming shafts 51, 51, and the reflection surface 5a faces the opening of the front surface of the housing 2. On the back side of the bottom surface of the reflector 5, a circular worm wheel 52 is formed. The central axis of the worm wheel 52 matches the central axis of the aiming shafts 51, 51. (See FIGS. 3 and 4.)

The extension 6 is a decorative member which is formed to be a near-cylindrical shape having an almost same outer diameter as the reflector 5. In addition, on the inner side of the lateral surface of the extension 6, aluminum vapor deposition or the like can be performed. The extension 6 is disposed in the vicinity of the opening of the front surface of the housing 2. Stays (shaft bearing portions) 61, 61 extending into the back direction are disposed on the right end and the left end of the back (bottom) portion of the extension 6, respectively. The aiming shafts 51, 51 of the reflector 5 are supported by shaft bearing holes 61a, 61a formed in the respective stays 61, 61. That is, while holding the reflector 5 in such a way that the reflector 5 is put between the stays 61, 61, the stays 61, 61 support the reflector 5 in such a way that the reflector 5 rotates. With regard to each of the stays 61, 61, the inner side of the stay 61 touches the outer side of the lateral surface of the reflector 5 while the outer side of the tip end (back end) of the stay 61 touches the inner side of the lateral surface of the housing 2. The extension 6 is made of elastic material, so that the stays 61, 61 have flexibility. Accordingly, the extension 6 is capable of elastically deformed in the direction of the central axis of the aiming shafts 51, 51, namely, in the right/left direction.

On the outer side of the front portion of the lateral surface of the extension 6, four engaging projections 62, 62, 62, 62 projecting outward are disposed. (Only two engaging projections 62, 62 are shown in FIG. 1.) The engaging projections 62, 62, 62, 62 are engaged with a recess 2a formed on the inner side of the lateral surface of the housing 2 in the vicinity of the opening of the front surface of the housing 2. Thereby, the extension 6 is fixed to the housing 2. “In the vicinity of the opening of the front surface of the housing 2” represents a region of the housing 2, the region which is close enough to the opening of the front surface thereof to visually check the engagement of the engaging projections 62, 62, 62, 62 with the recess 2a from the outside of the housing 2 when the extension 6 is installed in the housing 2.

The aiming screw 7 includes, as shown in FIGS. 3 and 4, a screw main body 71 having a worm gear 711 on the upper portion of the screw main body 71, and an adjustment gear member 72 attached to the lower end of the screw main body 71. The aiming screw 7 is inserted into and passes through an insertion aperture 2b so as to be installed in the housing 2. The worm gear 711 of the screw main body 71 meshes with the worm wheel 52 formed on the back side of the bottom surface of the reflector 5. The insertion aperture 2b is formed at the bottom portion of the housing 2. On the lower end of the screw main body 71, a groove 71a for the screw main body 71 to torsionally rotate is formed. On the adjustment gear member 72, a crown gear 721 is formed. A portion of the crown gear 721 is exposed from the housing 2 at the lower end of the housing 2 into the front direction.

In the headlight 1 described above, a driver or a specialized tool is used in order to mesh with the groove 71a of the screw main body 71 or the crown gear 721 of the adjustment gear member 72 so that the aiming screw 7 torsionally rotates. Thereby, the torque is conveyed from the worm gear 711 of the screw main body 71 to the worm wheel 52 formed on the back side of the bottom surface of the reflector 5. By receiving the torque, the reflector 5 tilts in the rotatory direction of the aiming shafts 51, 51, and the aiming adjustment can be performed accordingly.

Next, an assembling method of the headlight 1 is described.

First, the aiming screw 7 is assembled.

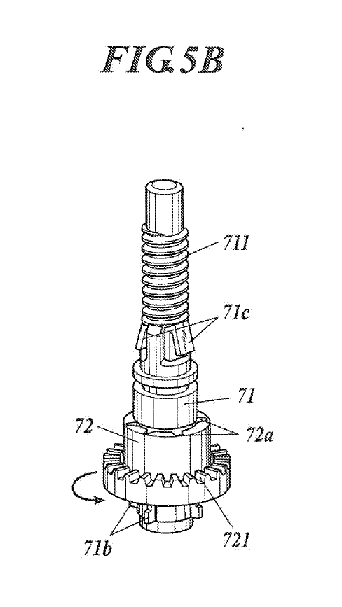

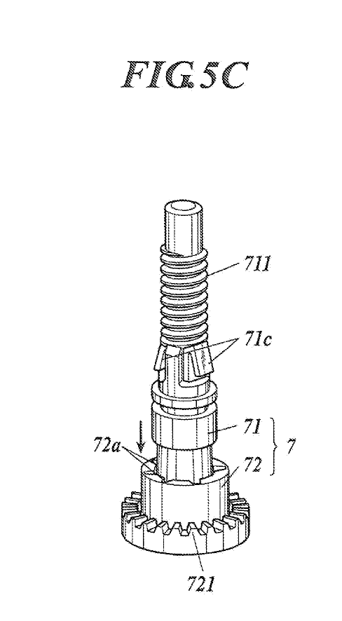

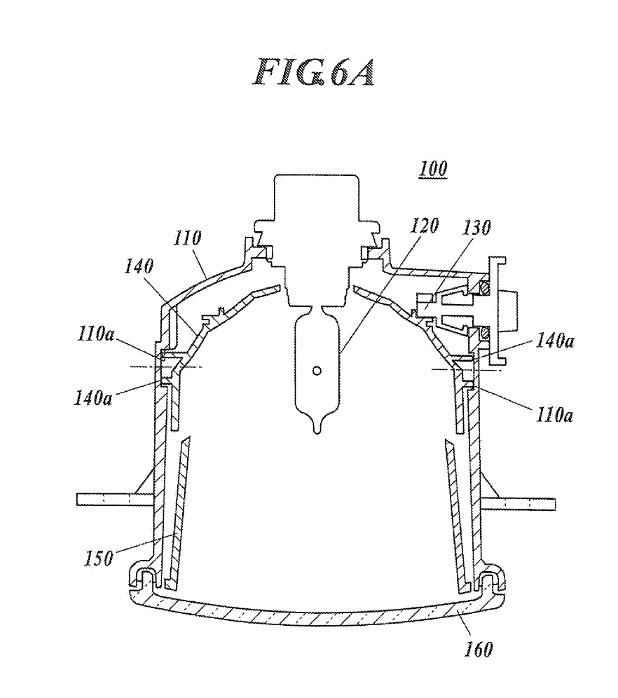

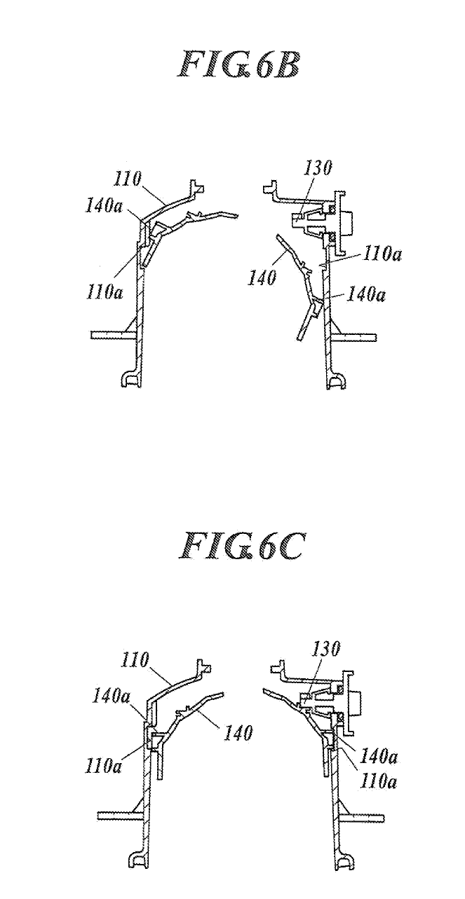

In assembling the aiming screw 7, first, the screw main body 71 is inserted into the adjustment gear member 72, and passes therethrough as shown in FIG. 5A. On the lower end of the screw main body 71, a plurality of fitting ribs 71b are formed. On the inner side of the lateral surface of the adjustment gear member 72, a plurality of insertion slits 72a and a plurality of fixing slits 72b (shown in FIG. 4) are formed in such a way as to be different in position. The fitting ribs 71b are respectively inserted into the insertion slits 72a so as to pass therethrough while the adjustment gear member 72 is attached to the screw main body 71 from the lower end thereof, and hence, the fitting ribs 71b are exposed from the lower end of the adjustment gear member 72.

Next, as shown in FIG. 5B, the adjustment gear member 72 is rotated so that the positions of the fitting ribs 71b match the positions of the fixing slits 72b, respectively.

Then, as shown in FIG. 5C, the adjustment gear member 72 is lowered to the lower end of the screw main body 71, so that the fitting ribs 71b fit the fixing slits 72b, respectively. Accordingly, the screw main body 71 and the adjustment gear member 72 are fixed to each other.

Next, the assembled aiming screw 7 is installed in the housing 2. The aiming screw 7 is inserted into the insertion aperture 2b, which is formed at the bottom portion of the housing 2, from the lower side of the housing 2. Engaging parts 71c of the screw main body 71 are respectively engaged with engaged parts 2c of the housing 2. Accordingly, the aiming screw 7 is fixed to the housing 2. (See FIGS. 3 and 4.)

Next, the reflector 5 is pressed into the extension 6. More specifically, the aiming shafts 51, 51 of the reflector 5 are supported by the shaft bearing holes 61a, 61a of the extension 6, respectively, in such a way that the aiming shafts 51, 51 rotate. Thereby, the reflector 5 and the extension 6 are integrated. (See FIG. 1.) Since the stays 61, 61 provided with the respective shaft bearing holes 61a, 61a are capable of being elastically deformed in the direction of the central axis of the aiming shafts 51, 51, the aiming shafts 51, 51 can be fitted into the shaft bearing holes 61a, 61a while the stays 61, 61 are bent. Accordingly, it can be avoided that excessive opposing force against the pressing is applied to the reflector 5.

Next, the reflector 5 and the extension 6 are installed in the housing 2. While the extension 6 is held, the extension 6 with the reflector 5 is inserted into the housing 2. The engaging projections 62, 62, 62, 62 are engaged with the recess 2a of the housing 2. Thereby, the extension 6 is fixed to the housing 2. (See FIGS. 1 and 2.) Thus, the reflector 5 is installed in the housing 2 in such a way as to be tiltable in a state where the focus of the reflection surface 5a is located in the vicinity of the filament 41, and the worm wheel 52 meshes with the worm gear 711 of the aiming screw 7. The inner side and the outer side of each of the stays 61, 61, between which the reflector 5 is put to be held, touch the reflector 5 and the housing 2, respectively. Accordingly, the stays 61, 61 can be prevented from being bent, and also the reflector 5 can be prevented from being displaced.

Lastly, the opening of the front surface of the housing 2 is covered with the lens 3, and the lens 3 is fixed to the housing 2.

Thus, the assembly of the headlight 1 is completed.

According to the headlight 1 and the assembling method of the headlight 1 described above, after the reflector 5 is supported by the stays 61, 61 of the extension 6, the reflector 5 supported by the extension 6 is inserted into the housing 2, and then, the extension 6 supporting the reflector 5 is engaged with and fixed to the housing 2 in the vicinity of the opening of the front surface of the housing 2.

That is, the reflector 5 can be inserted into the housing 2 in a state where the extension 6 is held. Accordingly, it can be prevented in the headlight 1 that the reflector 5 is obliquely inserted into the housing 2 even when the reflector 5 is inserted into the housing 2 to the bottom portion of the housing 2, unlike a conventional headlight assembled by directly holding a reflector which is difficult to be held when inserted into a housing, and inserting the reflector into the housing.

Furthermore, the reflector 5 is supported by the extension 6 outside the housing 2, and the extension 6 supporting the reflector 5 is engaged with and fixed to the housing 2 in the vicinity of the opening of the front surface of the housing 2. Accordingly, it can be easily judged in the headlight 1 whether an error occurs in installing the reflector 5 in the housing 2, unlike a conventional headlight assembled by fitting a reflector to a housing at the bottom portion of the housing.

Furthermore, the stays 61, 61 of the extension 6, the stays 61, 61 which support the reflector 5, have flexibility. Accordingly, it can be prevented in the headlight 1 that the reflector 5 is broken because of the opposing force from the housing 2, unlike a conventional headlight assembled by directly pressing a reflector into a robust housing. Furthermore, the reflector 5 is supported by the extension 6 outside the housing 2. Accordingly, even if the reflector 5 is broken, it can be immediately noticed.

The presently disclosed subject matter is not limited to the embodiment described above, and hence, can be appropriately modified without departing from the scope of the presently disclosed subject matter.

For example, in the embodiment, the aiming shafts 51, 51 are formed on the reflector 5, and the shaft bearing holes 61a, 61a are formed in the extension 6. However, as long as shafts and holes are fitted with each other in such a way that the shafts are supported by their respective holes, the holes can be formed in the reflector 5, and the shafts can be formed on the extension 6.

In the embodiment, the housing 2 supports the reflector 5 via the extension 6. However, the reflector 5 may be supported not by the extension 6 but by a separate supporting member. However, in terms of reduction of the number of components, one can use the extension 6 which is a decorative member as the supporting member by making the extension 6 function as the supporting member.

In the above-described embodiment, the extension 6 is made of elastic material. However, this is not a limit. What is necessary is that at least the stays 61, 61 are formed to have flexibility.

According to a first aspect of the embodiment of the presently disclosed subject matter, there is provided a vehicle headlight including: a housing including a front surface provided with an opening; a reflector which reflects light; and a supporting member including a plurality of shaft bearing portions which support the reflector, wherein the supporting member is made in such a way that at least the shaft bearing portions have flexibility, and engages with the housing in a vicinity of the opening of the front surface of the housing so as to be fixed to the housing, and the housing supports the reflector via the supporting member disposed in the housing in such a way that the reflector is tiltable in the housing.

The reflector can be located between the shaft bearing portions while the reflector is supported by the shaft bearing portions, and the shaft bearing portions touch both the reflector and the housing.

The reflector can include a lateral surface provided with one of a shaft and a hole, each of the shaft bearing portions is a stay provided with the other of the shaft and the hole at a tip end of the stay, the stay which is capable of being elastically deformed in a direction of a central axis of the one of the shaft and the hole of the reflector, and the supporting member supports the reflector by fitting the other of the shaft and the hole of the stay to the one of the shaft and the hole of the reflector.

The supporting member can be configured as an extension.

According to a second aspect of the embodiment of the presently disclosed subject matter, there is provided an assembling method of a vehicle headlight including: supporting a reflector by a plurality of shaft bearing portions of a supporting member, wherein the reflector reflects light, the supporting member is made in such a way that at least the shaft bearing portions have flexibility, and the supporting member is capable of engaging with a housing in a vicinity of an opening of a front surface of the housing; inserting the supporting member with the reflector into the housing while holding the supporting member; and engaging the supporting member with the housing so as to fix the supporting member to the housing, wherein the reflector is tiltable in the housing.

According to the above-described embodiment of the presently disclosed subject matter, after the reflector is supported by the shaft bearing portions, which have flexibility, of the supporting member, the reflector supported by the supporting member is inserted into the housing, and then, the supporting member supporting the reflector is engaged with and fixed to the housing in the vicinity of the opening of the front surface of the housing.

That is, the reflector can be inserted into the housing in a state where the supporting member is held. Accordingly, it can be prevented in the headlight that the reflector is obliquely inserted into the housing even when the reflector is inserted into the housing to the bottom portion of the housing, unlike a conventional headlight assembled by directly holding a reflector which is difficult to be held when inserted into a housing, and inserting the reflector into the housing.

Furthermore, the reflector is supported by the supporting member outside the housing, and the supporting member supporting the reflector is engaged with and fixed to the housing in the vicinity of the opening of the front surface of the housing. Accordingly, it can be easily judged in the headlight whether an error occurs in installing the reflector in the housing, unlike a conventional headlight assembled by fitting a reflector to a housing at the bottom portion of the housing.

Furthermore, the shaft bearing portions of the supporting member, the shaft bearing portions which support the reflector, have flexibility. Accordingly, it can be prevented in the headlight that the reflector is broken because of the opposing force from the housing, unlike a conventional headlight assembled by directly pressing a reflector into a robust housing. Furthermore, the reflector is supported by the supporting member outside the housing. Accordingly, even if the reflector is broken, it can be immediately noticed.

As described above, the headlight can be properly assembled, the headlight in which the reflector is supported in such a way as to be tiltable, and in which the aiming adjustment can be performed.

The entire disclosure of Japanese Patent Application No. 2010-116933 filed on May 21, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

1. A vehicle headlight comprising:
a housing including a front surface provided with an opening;
a reflector configured to reflect light; and
a supporting member including a plurality of shaft bearing portions which support the reflector, wherein
the supporting member is configured such that at least the shaft bearing portions have flexibility, and engage with the housing in a vicinity of the opening of the front surface of the housing so as to be fixed to the housing, and
the housing supports the reflector via the supporting member disposed in the housing in such a way that the reflector is tiltable in the housing.

2. The vehicle headlight according to claim 1, wherein
the reflector is located between the shaft bearing portions while the reflector is supported by the shaft bearing portions, and
the shaft bearing portions are in contact with both the reflector and the housing.

3. The vehicle headlight according to claim 1, wherein
the reflector includes a lateral surface provided with one of a shaft and a hole,
each of the shaft bearing portions is a stay provided with the other of the shaft and the hole at a tip end of the stay, the stay being elastically deformable in a direction of a central axis of the one of the shaft and the hole of the reflector, and
the supporting member supports the reflector by fitting the other of the shaft and the hole of the stay to the one of the shaft and the hole of the reflector.

4. The vehicle headlight according to claim 1, wherein the supporting member is an extension.

5. An assembling method of a vehicle headlight comprising:
providing a housing, a reflector, and a supporting member including a plurality of shaft bearing portions;
supporting the reflector by the plurality of shaft bearing portions of the supporting member, wherein the reflector is configured to reflect light, the supporting member is made in such a way that at least the shaft bearing portions have flexibility, and the supporting member is configured to engage with the housing in a vicinity of an opening of a front surface of the housing;
inserting the supporting member with the reflector into the housing while holding the supporting member; and
engaging the supporting member with the housing so as to fix the supporting member to the housing, wherein
the reflector is tiltable in the housing.

6. The method of claim 5, wherein supporting the reflector by the plurality of shaft bearing portions of the supporting member includes supporting the reflector such that the reflector can rotate about a rotational axis defined by the shaft bearing portions.

7. The method of claim 6, wherein the rotational axis is perpendicular to a light emitting axis for the vehicle headlight.

8. The vehicle headlight according to claim 1, wherein the plurality of shaft bearing portions define a rotational axis about which the reflector is configured to rotate.

9. The vehicle headlight according to claim 1, further comprising:
an aiming device operationally connected with the reflector such that an amount of tilt of the reflector with respect to the housing can be controlled.

10. The vehicle headlight according to claim 1, wherein the reflector includes a mating plurality of shaft bearing portions that mate with the plurality of shaft bearing portions of the support member such that the reflector is configured to rotate with respect to the support member.

11. The vehicle headlight according to claim 10, wherein the mating plurality of shaft bearing portions of the reflector are configured as shafts.

12. The vehicle headlight according to claim 10, wherein the plurality of shaft bearing portions of the support member are configured as holes.
